(19) United States
(12) Patent Application Publication
(10) Pub. No.: US 2013/0275179 A1
(43) Pub. Date: Oct. 17, 2013

(54) Methods, Devices and Systems for Referral Opportunity Identification in Social Media Settings

(71) Applicant: Michael Martin Marshall, Austin, TX (US)

(72) Inventor: Michael Martin Marshall, Austin, TX (US)

(21) Appl. No.: 13/834,770

(22) Filed: Mar. 15, 2013

Related U.S. Application Data
(60) Provisional application No. 61/613,801, filed on Mar. 21, 2012.

(51) Int. Cl. G06Q 30/02; G06Q 50/00

(52) U.S. Cl. CPC G06Q 30/0214; G06Q 50/01
USPC 705/7.29; 705/14.16

(57) ABSTRACT

In some embodiments, opportunities for a customer of a business to recommend the business may be automatically identified within the customer's social media account. The customer may grant a third-party application access to his social media account, which is then monitored or occasionally scanned for keywords that identify opportunities such as open requests for referrals. The customer may be presented with the requests and allowed to post a referral for the business. When the referral results in a new customer for the business, both the existing customer and the new customer may receive a reward, such a voucher for a gift card.

### CROSS-REFERENCE TO RELATED APPLICATIONS

This application claims priority to U.S. Provisional Patent Application No. 61/613,801, filed Mar. 21, 2012, which is incorporated by reference in its entirety.

### FIELD OF THE INVENTION

The instant disclosure relates to social media. The instant disclosure more specifically relates to generating business referrals through social media.

### SUMMARY

According to one embodiment, a method includes accessing a referrer's social media account. The method also includes scanning content in the social media account. The method further includes identifying a referral opportunity in the social media content. The method also includes notifying the referrer of the referral opportunity.

In further embodiments, the method may include posting a referral for a business through the referrer's social media account, determining when a new customer relationship is established through the referral, rewarding the referrer and a customer associated with the new customer relationship, generating a voucher redeemable for a gift certificate, and/or collecting a referral fee from the business after the new customer relationship is established.

In other embodiments, a method can include receiving information relating to a business; receiving information relating to a customer; receiving information relating to a referrer; generating a unique referral code associated with the referrer; delivering the unique referral code to the customer; and delivering a reward to the customer and the referrer if confirmation of use of the unique referral code is received.

According to another embodiment, a computer program product includes a non-transitory computer readable medium having code to access a referrer's social media account. The medium also includes code to scan content in the social media account. The medium further includes code to identify a referral opportunity in the social media content. The medium also includes code to notify the referrer of the referral opportunity.

According to yet another embodiment, an apparatus includes a memory and a processor. The processor is configured to access a referrer's social media account. The processor is further configured to scan content in the social media account. The processor is also configured to identify a referral opportunity in the social media content. The processor is further configured to notify the referrer of the referral opportunity.

In some embodiments, the processor may be a general purpose processor running program instructions. Alternatively, the processor may be a processor specifically configured to carry out one or more the present methods.

In some embodiments, the present systems can comprise a memory and a processor linked to the memory, the processor configured to receive information relating to a business; receive information relating to a customer; receive information relating to a referrer; generate a unique referral code associated with the referrer; deliver the unique referral code to the customer; and deliver a reward to the customer and the referrer if the system receives confirmation that the unique referral code was used.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus or kit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

The term “processor” is used generally throughout this disclosure to describe any device capable of performing the functions described in this disclosure. For example, the functions may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Any embodiment of any of the present methods, devices, and systems can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

For a more complete understanding of the disclosed methods, devices, and systems, reference is now made to the following descriptions taken in conjunction with the accompanying drawings. The drawings illustrate by way of example and not limitation.

FIG. 1 is a flow chart illustrating a method for identifying referral opportunities according to one embodiment of the disclosure.

FIG. 2 is a block diagram illustrating a referral posted in response to an identified referral opportunity according to one embodiment of the disclosure.

FIG. 3 is a flow chart for obtaining customer referrals according to one embodiment of the disclosure.

FIG. 4 is a block diagram illustrating an information system according to one embodiment of the disclosure.

FIG. 5 is a block diagram illustrating a computer system according to one embodiment of the disclosure.

FIG. 6 is a flow chart illustrating one way in which a reward can be delivered according to one embodiment of this disclosure.

FIG. 7 is a flow chart illustrating a method for delivering a reward according to one embodiment of this disclosure.

### DETAILED DESCRIPTION

A referral-based system can improve customer retention and increase the existing customer base by offering rewards to both the referrer and referee. An existing customer can become a referrer for a business by posting referrals (e.g., directly or indirectly via a website or a web application) to his or her social media account. When a new customer uses the referral link to purchase products from the business, the business rewards the referrer and the referee (e.g., the customer). The referral amount may be, for example, determined by the business.

In addition to posting referrals on his social media account, the referrer can post responses to a social contact's postings seeking referrals. To improve the identification of referral opportunities, the referrer's social media account may be scanned for keywords related to businesses the referrer identifies. For example, a web application may be granted permission to access the referrer's social media account. When friends of the referrer create posts with keywords identifying a request for a business similar to one the referrer has identified, an email is generated automatically informing the referrer of a possible referral opportunity. The referrer may then send a referral link to the friend. In some embodiments, a link can be automatically sent to the friend if friends of the referrer create posts with keywords identifying a request for a business similar to one the referrer has identified. When the friend visits the business through the referral link, the referrer and the friend may receive rewards from the business as described in this disclosure.

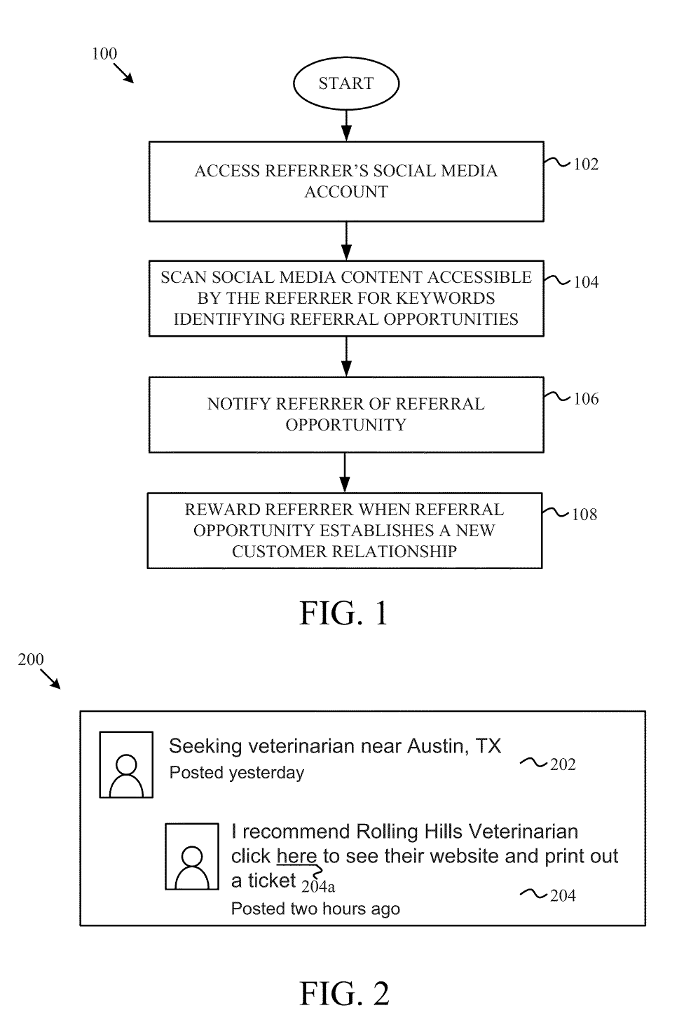

Successful referral rates may be improved by automatically detecting referral opportunities available to a referrer. FIG. 1 is a flow chart illustrating a method for identifying referral opportunities according to one embodiment of the disclosure. Method 100 begins at block 102 with accessing a referrer's social media account. The media account may be, for example, a Facebook account, a Twitter account, a LinkedIn account, or the like. Before the media account is accessed, the referrer may grant access to the social media account through an third-party web page or application. The referrer may provide access to the social media account by adding an application to the social media account through a directory of applications. Alternatively, the referrer may access a third-party's web site for handling referrals, create an account at the third-party website, and grant the third-party website access to the social media account. In such an alternative, the third-party website can be configured to permit a referrer to post links associated with a business to one or more of the referrer's social media accounts.

At block 104, the social media content accessible by the referrer is scanned to identify keywords and/or phrases that indicate a possible referral opportunity. For example, messages and posts from friends associated with the referrer may be scanned. A post or message may include the text “seeking veterinarian near Austin, Tex.” Referral opportunities may be identified by scanning for keywords such as “seeking ” According to one embodiment, specific referral opportunities for a referrer may be identified when the referrer first identifies businesses that the referrer has visited. For example, if the referrer indicated that he had previously visited “Rolling Hills Veterinarian” then the keywords may include “veterinarian” as well as “seeking.”

The scanning step of block 104 may be performed on demand by the referrer or automatically as a background task by a third-party web site. For example, while the referrer is accessing the social media account, the referrer may click on a link to “scan for referral opportunities.” In another example, when the referrer has granted an application or a third-party website access to the referrer's social media account, a background script executed either by a host of the social media account or the third-party website may identify referral opportunities. The backgrounds script may be executed one or more times per day, such as at scheduled or periodic intervals. The background script may also be executed when a certain number of new social media content are available to the referrer's social media account, such as when at least 10 new messages or posts are available to the referrer's social media account.

At block 106, the referrer is notified of the referral opportunity. The notification may be, for example, by automatic email. When a new referral opportunity is identified by scanning at block 104, an email may be generated displaying the referral opportunity. Additionally, a daily or weekly digest email may be transmitted to the referrer indicating all of the referral opportunities available during the last day or last week, respectively. The notification may also be, for example, a pop-up window on the referrer's screen while the referrer is accessing the social media account. For example, while reading messages from friends, a pop-up window may alert the referrer to the opportunity. In some embodiments, a third-party application or website can be configured to permit the referrer to automatically respond to the referral opportunity. For example, a referrer can select an option on a third-party website or application such that a third-party system responds to a referral opportunity on the referrer's behalf.

After receiving notification of the referral opportunity, the referrer may post or send a message responding to the original message. The post may include a tracking identification code for tracking new customer relationships created based on the referral. The tracking identification code may be a number embedded in a link to the business's website. When a referee accesses the business through the link containing the embedded code, the business identifies the referrer as the source of the customer relationship. The post may also include a printable ticket, which may be scanned in-person at the business to identify the source of the new customer relationship.

When the referee establishes a new customer relationship with the business through the referral, the referrer and the referee (e.g., a customer) may be rewarded. For example, an email, containing a voucher redeemable for a gift card, may be generated and transmitted to the referee and the referrer. The email may be generated automatically when the referee completes a transaction with the business, such as a purchase of goods or a payment for services. The value of the gift card may be specified by the business. In other embodiments, as described below, a reward may be delivered to the referrer and the customer in any suitable way, including by email, by display in a browser, by social media account, and the like.

FIG. 2 is a block diagram illustrating a referral posted in response to an identified referral opportunity according to one embodiment of the disclosure. A social media site may present a referral opportunity 202. The opportunity 202 may be identified and presented to a referrer, who posts a message 204 responding to the opportunity 202. The message 204 may include a link 204a, having a tracking identification code. When a new customer relationship is developed through the message 204 and associated with the referrer through the tracking identification code, the referrer and referee are rewarded.

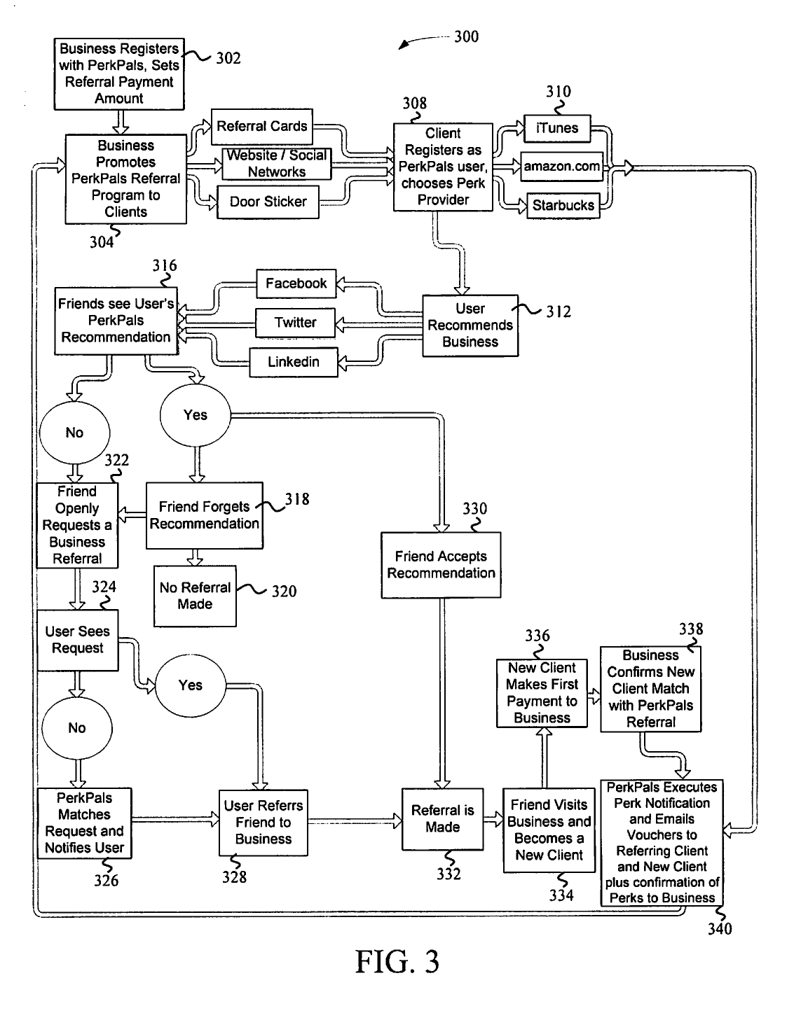

FIG. 3 is a flow chart for obtaining customer referrals according to one embodiment of the disclosure. A method 300 begins at block 302 with a business registering with a third-party referral system and setting referral payment amounts. At block 304, the business promotes the third-party referral system to its clients. For example, the business may provide referral cards, website advertisements, social network advertisements, and/or door stickers. At block 308, a current customer of the business registers with the third-party system. The current customer may be provided an opportunity to select a reward provider at block 310 for receiving referral rewards. For example, gift cards from merchants such as iTunes, amazon.com, and Starbucks may be available as a reward.

At block 312, the current customer (e.g., a referrer) recommends the business by providing a referral on a social media website, such as Facebook, Twitter, or LinkedIn. At block 316, other users of the social media website view the current customer's recommendation. If another user views the recommendation posted at block 316, but forgets the recommendation at block 318, the other user may openly request a business referral at block 322. Openly requesting a referral at block 322 may include posting of certain keywords or phrases that are recognizable by scanning the social media website. Such a phrase may be, for example, “seeking veterinarian near Austin, Tex.” In this example, if the other user views the recommendation posted at block 316, but forgets the recommendation at block 318, then the referral is not made and the process terminates at block 320.

When a user openly requests a business referral at block 322, the current customer may or may not see the request at block 324. If the current customer does see the request, then the current customer may refer the other user to the business at block 328. If the current customer does not see the request, then an automatic scanning of the current customer's social media account may identify the request at block 326. The current customer may refer the friend to the business at block 328 after notification of the referral opportunity detected at block 326. The scanning for referral opportunities is described in further detail above with reference to FIG. 1.

At block 330, the other user may accept the current customer's original recommendation posted at block 312. The other user may also accept the current customer's recommendation in response to the open request at block 328. In either case, the referral is completed at block 332, resulting in the other user visiting the business, whether online or in person, and becoming a new customer at block 334. The new customer makes a first purchase at block 336. At block 338, the business confirms the new customer relationship resulted from the referral at block 332. At block 340, vouchers for referral rewards are generated and transmitted to the new customer and the current customer. The operator of the referral service may collect a referral fee when the referral is complete.

The methods described above for referring customers to a business through social media websites may improve the retention rate of current customers and improve the recruiting rate of new customers. By rewarding current customers for recommending the business to other users on the social media website, the current customer is incentivized to refer friends to the business. The rewards to the current customer keep the current customer interested in the business, thus improving repeat business from the current customer. Providing a reward to the new customer for visiting the business and making a purchase incentivizes the new customer to follow-up on the recommendation made by the current customer. Thus, the referral is more likely to be effective at bringing in new customers.

A third-party application for identifying referral opportunities decreases the likelihood that an opportunity to refer new customers is missed by current customers. Even when the current customer is provided incentives for recommending the business, the current customer may be unable to continuously monitor social media websites for opportunities to recommend the business. Even if the current customer continuously monitors the social media websites, human error is still likely to result in missed opportunities. By allowing a third-party application access to the current customer's social media accounts, the third-party application may scan to identify referral opportunities and notify the current customer.

The steps of methods or algorithms described in this disclosure may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art; all of these are examples of physical storage media. An exemplary storage medium is coupled to a processor such that the processor can read information from, and write information to, the storage medium. In the alternative, the storage medium may be integral to the processor. The processor and the storage medium may reside in an ASIC. The ASIC may reside in a user terminal. In some embodiments, the processor and the storage medium may reside as discrete components in a user terminal.

If implemented in firmware and/or software, the functions described above may be stored as one or more instructions or code on a computer-readable medium. Examples include non-transitory computer-readable media encoded with a data structure and/or a computer program. Non-transitory computer-readable media includes physical computer storage media. A storage medium may be any available medium that can be accessed by a computer. By way of example, and not limitation, such non-transitory computer-readable media can comprise RAM, ROM, EEPROM, CD-ROM, DVD-ROM, a flash drive, a hard drive, or other optical disk storage, magnetic disk storage, or other magnetic storage devices, or any other medium that can be used to store desired program code in the form of instructions or data structures and that can be accessed by a computer. Under general usage, disk and disc includes compact discs (CD), laser discs, optical discs, digital versatile discs (DVD), floppy disks, and blu-ray discs. Disks reproduce data magnetically, and discs reproduce data optically. Combinations of the above may also be included within the scope of non-transitory computer-readable media.

Some embodiments of the present methods include recording a non-transitory computer-readable medium with computer-readable code that, when executed by a computer, causes the computer to perform any of the operations discussed herein, including those associated with the present non-transitory computer-readable media. Recording the non-transitory computer-readable medium may include, for example, burning data onto a CD-ROM or a DVD-ROM, or otherwise populating a physical storage device with the data.

In addition to storage on computer readable medium, instructions and/or other data may be provided as signals on transmission media included in a communication apparatus. For example, a communication apparatus may include a transceiver having signals indicative of instructions and other data. The instructions and other data are configured to cause one or more processors to implement the functions outlined in the claims.

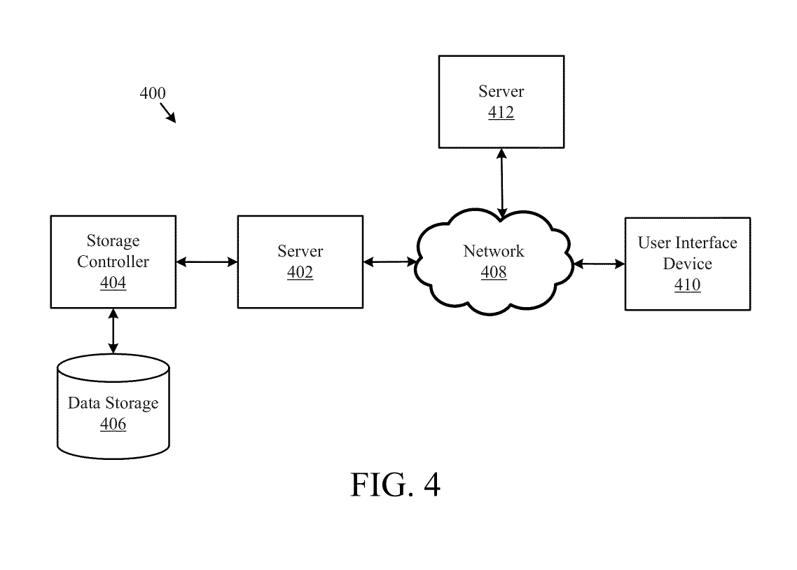

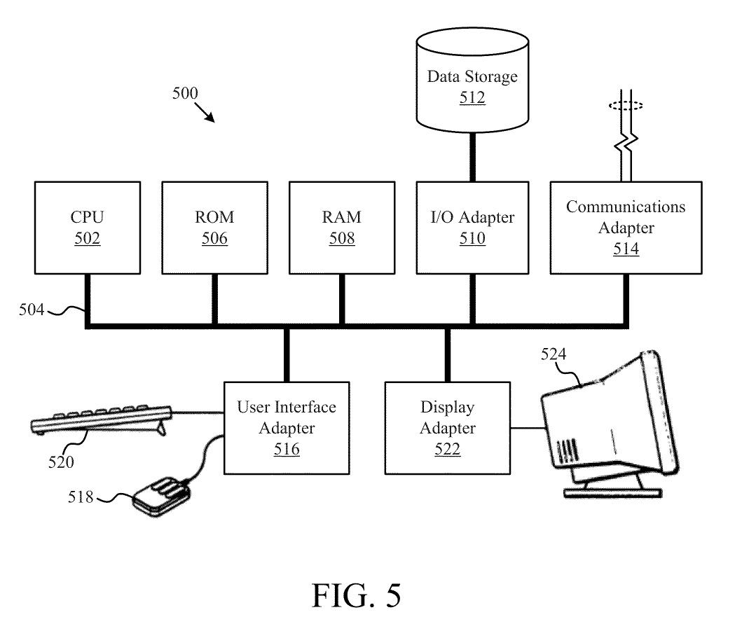

Embodiments of systems capable of executing the methods or instructions described above are described in FIGS. 4 and 5. However, these embodiments are non-limiting and other embodiments for carrying out the methods or executing the instructions are possible. FIG. 4 illustrates one embodiment of a system 400 for an information system, such as a system for managing social media content. The system 400 may include a server 402, a data storage device 406, a network 408, and a user interface device 410. The server 402 may be a dedicated server or one server in a cloud computing system for handling social media content. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408. The server 402 may host social media content accessible via the Internet, such as user accounts for Facebook, Twitter, or LinkedIn.

A third-party server 412 may also be connected to the network 408. The third-party server 412 may access the social media content on the server 402 with a user's permission through, for example, an application programming interface (API) on the server 402. The server 412 may host scripts, macros, or other programs that scan social media content on the server 402. For example, the server 412 may scan messages and posts in a user's social media account for referral opportunities. A user may access their social media account on the server 402 over the network 410 through a user interface device 410. The user may also access a referral account on the server 412 through the network 408.

In one embodiment, the user interface device 410 is referred to broadly and is intended to encompass a suitable processor-based device such as a desktop computer, a laptop computer, a personal digital assistant (PDA) or tablet computer, a smartphone or other a mobile communication device having access to the network 408. When the device 410 is a mobile device, sensors (not shown), such as a camera or accelerometer, may be embedded in the device 410. When the device 410 is a desktop computer the sensors may be embedded in an attachment (not shown) to the device 410. In a further embodiment, the user interface device 410 may access the Internet or other wide area or local area network to access a web application or web service hosted by the servers 402 and 412 and provide a user interface for enabling a user to enter or receive information.

The network 408 may facilitate communications of data, such as authentication information, between the servers 402 and 412 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts that permits two or more computers to communicate. In one embodiment, the user interface device 410 accesses the servers 402 and 412 through an intermediate sever (not shown).

FIG. 5 illustrates a computer system 500 adapted according to certain embodiments of the server 402, the server 412, and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 also may include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The communications adapter 514 may also be adapted to couple the computer system 500 to other networks such as a global positioning system (GPS) or a Bluetooth network. The user interface adapter 516 couples user input devices, such as a keyboard 620, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or gyroscope may be coupled to the user interface adapter 516. The display adapter 522 may be driven by the CPU 502 to control the display on the display device 524. Any of the devices 502-522 may be physical or logical.

The applications of the present disclosure are not limited to the architecture of computer system 500. Rather the computer system 500 is provided as an example of one type of computing device that may be adapted to perform the functions of a server 402, server 412, and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

The use of a processor or processors allows for the processing of information (e.g., data) that is not possible without the aid of a processor or processors, or at least not at the speed achievable with a processor or processors. Some embodiments of the performance of such operations may be achieved within a certain amount of time, such as an amount of time less than what it would take to perform the operations without the use of a computer system, processor, or processors, including no more than one hour, no more than 30 minutes, no more than 15 minutes, no more than 10 minutes, no more than one minute, no more than one second, and no more than every time interval in seconds between one second and one hour.

For example, one embodiment of the present systems can comprise a memory (e.g., similar to data storage 512) and a processor (e.g., similar to CPU 502). In this embodiment, the system can be configured to receive information relating a business. For example, a business may elect to offer referral rewards on a third-party website or through at third-party application to encourage use of its goods or services. A person acting on behalf of a business can input information relating to the business at a third-party website or a third-party application. Information relating to a business can include, for example business name, business website address, business email address, business phone number, business mailing address, contact name, contact email address, contact phone number, and information relating to a reward (e.g., value of reward selected by business). The system is configured to store information relating to the business (e.g., in the memory). In some embodiments, the third-party website/application can be configured to search by information relating to a business. For example, if a user inputs information relating to a business into a search field, the system (e.g., the processor) can be configured to compare the information relating to the business to information in the memory and to return a result if the information relating to the business input by the user is similar to information in the memory (e.g., previously stored in the memory).

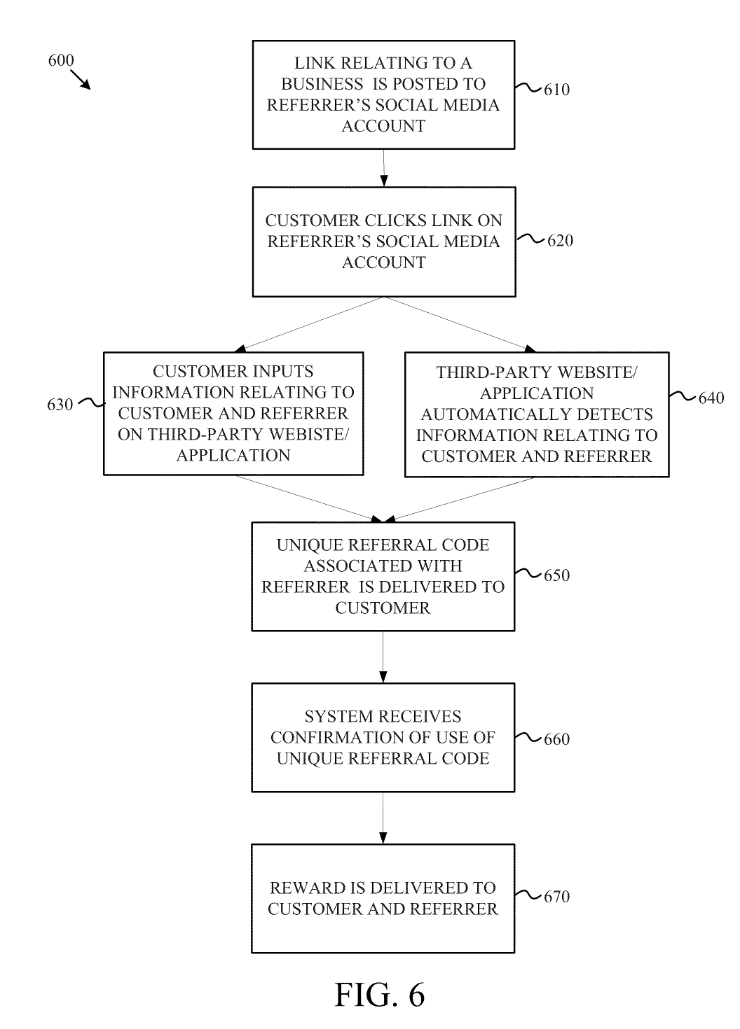

Referring now to FIG. 6, the systems of the present disclosure can further be configured to receive information relating to a customer. For example, as depicted in FIG. 6, a referrer may post a link relating to a business on the referrer's social media account(s) (as depicted in block 610). In some embodiments, a third-party website or application may post a link relating to a business on one or more of the referrer's social media accounts on the referrer's behalf (e.g., automatically, or if a referrer authorizes the third-party to do so). In some embodiments, the system may be configured such that a link relating to a business is posted to the referrer's social media account if a referrer checks-in at a business (e.g., via Facebook, Foursquare, and similar websites and applications configured to check-in users). If a customer selects the link (as in block 620), the link may direct a customer to a third-party website or application. As shown in block 630, the customer may then be asked (e.g., via empty fields at a destination) for information relating to the customer, such as customer name, customer email address, and the like. The customer can input the requested information, and the information can be stored in the system. In other embodiments, as in block 640, the system automatically receives information relating to the customer if the customer selects the link. For example, a third-party website or application can detect (e.g., collect or receive) information from the customer's social media account such that the customer is not required to input information into a third-party website or application.

The system is further configured to receive information relating to a referrer. For example, if a customer selects a link (as shown in block 620), the link may direct a customer to a third-party website or application, where the customer is asked (e.g., via empty fields at a destination) for information relating to the customer and information relating to the referrer, such as referrer name and referrer email address. The customer can input the requested information, and the information can be stored in the system. In other embodiments, as in block 640, the system automatically receives information relating to the referrer if the customer selects the link. For example, when the link is posted to the referrer's social media account, the link can contain information relating to the referrer (e.g., collected or received from the referrer's social media account). If a customer selects the link, such information relating to the referrer can be received by the system such that the customer is not required to input information into a third-party website or application. In other embodiments, a link posted to a referrer's social media account may not have information relating to the referrer; however, if the customer selects the link, a third-party application or website can detect (e.g., collect or receive) information from the referrer's social media account.

The systems of this disclosure are also configured to generate a unique referral code associated with the referrer. For example, after the system receives information relating to the customer and the referrer, the system can generate a unique referral code associated with the referrer (e.g., such that the referrer can be identified if the unique referral code is used) and deliver the unique referral code to the customer (as shown in block 650). A unique referral code can comprise any unique identifier, such as, for example, a numeric identification code, a linear bar code (e.g., UPC code), a matrix bar code (e.g., QR code), and the like. In some embodiments, the system is configured to deliver the unique referral code to the customer by email; in other embodiments, the system is configured to deliver the unique referral code to the customer's social medial account(s); and in still other embodiments, the system is configured to deliver the unique referral code to the customer by displaying the unique referral code in the customer's browser.

The present systems are further configured to deliver a reward to the customer and the referrer if the system (e.g., a processor) receives confirmation that the unique referral code was used (e.g., by the customer, as depicted in blocks 660 and 670). In some embodiments, the system is configured to deliver the reward to the customer and the referrer by email; in other embodiments, the system is configured to deliver the reward to the customer's and referrer's social medial account(s); and in other embodiments, the system is configured to deliver the reward to the customer and the referrer by displaying the reward in the customer's browser; and in still other embodiments, the system is configured to deliver the reward to the customer and the referral by mail. In some embodiments, the system is configured to permit the customer, the referrer, and/or the business to choose the reward (e.g., among a listing of rewards).

The present systems are configured, for example, to receive confirmation that the unique referral code was used from the business. As depicted in block 660, a customer can visit the relevant business (e.g., the business for which the link was posted on the referrer's social media account, the business to which the unique referral code relates, etc.) by, for example, visiting the business's website, visiting an in-store location of the business, communicating with the business by telephone, and the like. In some embodiments, a customer may present the unique referral code to the business, and the business may confirm the unique referral code such that a reward is delivered to the customer and to the referrer. In some embodiments, the business can confirm the unique referral code by inputting the unique referral code into a third-party website or application (e.g., if the customer shows the unique referral code to the business). In some embodiments, the system is configured to receive a signal (e.g., a confirmation signal) relating to the unique referral code if the business scans (e.g., with a mobile device, a bar code scanner, etc.) the unique referral code (e.g., if the unique referral code is a QR code). In other embodiments, the system is configured to receive a signal (e.g., a confirmation signal) relating to the unique referral code by near field communication (e.g., if the unique referral code is communicated from a device of the customer to a device of the business via near field communication).

In some embodiments, the system is configured to deliver a reward to the customer and the referrer if the system receives a business referral fee from the business (e.g., in addition to receiving confirmation of use of the unique referral code). Such a fee can be paid, for example, at the time of confirmation of the unique referral code, in given time intervals, or after a given number of uses. In some embodiments, a business may choose to confirm the unique referral code (such that the system can receive confirmation of the unique referral code to deliver rewards) if the customer transacts business with the business, for example, by purchasing purchases goods or services.

The present disclosure also relates to generating reports relating to information in the system or information derived from use of the systems and methods of this disclosure. For example, a system can be configured to generate a report for a business, a customer, or a referrer. Such a report can be accessible, for example, via third-party application or website, or can be delivered via email.

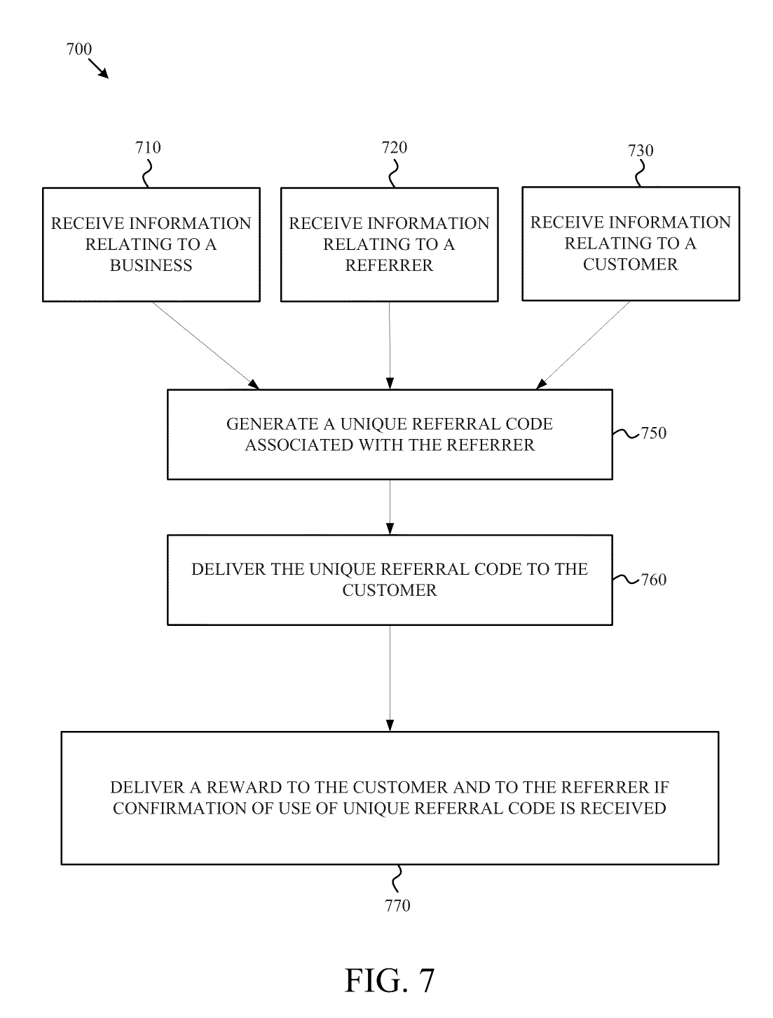

Referring now to FIG. 7 is another embodiment of the present methods. For example, such methods comprise receiving information relating to a business (e.g., block 710); receiving information relating to a customer (e.g., block 730); receiving information relating to a referrer (e.g., block 720); generating a unique referral code associated with the referrer (e.g., block 750); delivering the unique referral code to the customer (e.g., block 760); and delivering a reward to the customer and the referrer if confirmation that the unique referral code was used is received (e.g., block 770).

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than those shown may include some or all of the features of the depicted embodiments. For example, in addition to scanning for keywords, natural language searches or regular expressions may be employed to detect referral opportunities in social media accounts. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method, comprising:
accessing a referrer's social media account;
scanning content in the social media account;
identifying a referral opportunity in the social media content; and
notifying the referrer of the referral opportunity.

2. The method of claim 1, further comprising posting a referral for a business through the referrer's social media account.

3. The method of claim 2, further comprising determining when a new customer relationship is established through the referral.

4. The method of claim 3, further comprising rewarding the referrer and a customer associated with the new customer relationship.

5. The method of claim 4, in which the step of rewarding the referrer and the customer comprises generating a voucher redeemable for a gift certificate.

6. The method of claim 4, further comprising collecting a referral fee from the business after the new customer relationship is established.

7. The method of claim 1, in which the referrer's social media account is at least one of a Facebook account, a Twitter account, and a LinkedIn account.

8. A computer program product, comprising:
a non-transitory computer readable medium comprising:
code to access a referrer's social media account;
code to scan content in the social media account;
code to identify a referral opportunity in the social media content; and
code to notify the referrer of the referral opportunity.

9. The computer program product of claim 8, in which the medium further comprises code to post a referral for a business through the referrer's social media account.

10. The computer program product of claim 9, in which the medium further comprises code to determine when a new customer relationship is established through the referral.

11. The computer program product of claim 10, in which the medium further comprises code to reward the referrer and a customer associated with the new customer relationship.

12. The computer program product of claim 11, in which the medium further comprises code to generate a voucher redeemable for a gift certificate.

13. The computer program product of claim 11, in which the medium further comprises code to collect a referral fee from the business after the new customer relationship is established.

14. The computer program product of claim 13, in which the referrer's social media account is at least one of a Facebook account, a Twitter account, and a LinkedIn account.

15. A system comprising:
a memory; and
a processor linked to the memory, the processor being configured to:
access a referrer's social media account;
scan content in the social media account;
identify a referral opportunity in the social media content; and
notify the referrer of the referral opportunity.

16. The system of claim 15, in which the processor is further configured to post a referral for a business through the referrer's social media account.

17. The system of claim 16, in which the processor is further configured to determine when a new customer relationship is established through the referral.

18. The system of claim 17, in which the processor is further configured to reward the referrer and a customer associated with the new customer relationship.

19. The system of claim 18, in which the processor is further configured to generate a voucher redeemable for a gift certificate.

20. The system of claim 18, in which the processor is further configured to collect a referral fee from the business after the new customer relationship is established.

21. The system of claim 15, where the system is configured such that the referrer automatically responds to the referral opportunity.

22. A system comprising:
a memory; and
a processor linked to the memory;
where the system is configured to:
receive information relating to a business;
receive information relating to a customer;
receive information relating to a referrer;
generate a unique referral code associated with the referrer;
deliver the unique referral code to the customer; and
deliver a reward to the customer and the referrer if the system receives confirmation that the unique referral code was used.

23. The system of claim 22, where information relating to a business comprises at least one of business name, business website address, business email address, business phone number, business mailing address, contact name, contact email address, contact phone number, and information relating to a reward.

24. The system of claim 23, where the system is configured to store the information relating to a business in the memory.

25. The system of claim 24, where the system is further configured to:
if the system receives information relating to a business, compare the information relating to the business to information in the memory and;
return a result if the information relating to the business is similar to information in the memory.

26. The system of claim 22, where information relating to a customer comprises at least one of customer name and customer email address.

27. The system of claim 22, where information relating to a referrer comprises at least one of referrer name and referrer email address.

28. The system of claim 22, where the system delivers the unique referral code to the customer by email.

29. The system of claim 22, where the system delivers the unique referral code to the customer by displaying the unique referral code in the customer's browser.

30. The system of claim 22, where the system delivers the reward to the customer and the referrer by email.

31. The system of claim 22, where the system delivers the reward to the customer and the referrer by displaying the reward in the customer's browser and in the referrer's browser.

32. The system of claim 22, where the system receives confirmation that the unique referral code was used from the business.

33. The system of claim 22, where the system receives confirmation that the unique referral code was used if the system receives a signal relating to the unique referral code from the business.

34. The system of claim 33, where the system delivers the reward to the customer and the referrer if the system also receives a business referral fee from the business.

35. The system of claim 33, where the system receives a signal relating to the unique referral code from the business if the business scans the unique referral code.

36. The system of claim 35, where the unique referral code comprises a quick response (QR) code.

37. The system of claim 33, where the system receives a signal relating to the unique referral code by near field communication.

38. The system of claim 22, where the system is further configured to:
generate a report, where the report comprises information relating to at least one of the customer, the referrer, and the business.

39. The system of claim 22, where the system is configured to permit at least one of the customer, the referrer, and the business to choose the reward.

40. The system of claim 22, where the system is further configured to:
post a link relating to a business to a social media account of a referrer.

41. The system of claim 40, where the link comprises information relating to the referrer.

42. The system of claim 40, where if a customer uses the link, the system is configured to automatically receive information relating to the customer and information relating to the referrer.

43. The system of claim 42, where if a customer uses the link, the system is configured to automatically generate a unique referral code associated with the referrer.

44. The system of claim 22, where the system is further configured to:
post a link relating to a business to a plurality of social media accounts of a referrer.

45. The system of claim 40, where the system is configured to post a link relating to a business to a social media account of a referrer if the referrer checks-in at a business.

46. A method comprising:
receiving information relating to a business;
receiving information relating to a customer;
receiving information relating to a referrer;
generating a unique referral code associated with the referrer;
delivering the unique referral code to the customer; and
delivering a reward to the customer and the referrer if confirmation of use of the unique referral code is received.
